(19) United States
(12) Patent Application Publication
(10) Pub. No.: US 2020/0300638 A1
(43) Pub. Date: Sep. 24, 2020

(54) DEFINITION OF ONE OR MORE GATEWAYS FOR LINKING NAVIGATION DATA SETS REPRESENTING MAPS OF AT LEAST PARTIALLY OVERLAPPING GEOGRAPHIC REGIONS

(71) Applicant: HERE GLOBAL B.V., Eindhoven (NL)

(72) Inventor: Martin PFEIFLE, Seewald (DE)

(73) Assignee: HERE GLOBAL B.V., Eindhoven (NL)

(21) Appl. No.: 16/089,704

(22) PCT Filed: Mar. 31, 2016
(86) PCT No.: PCT/EP2016/057071

§ 371 Date: Sep. 28, 2018

(51) Int. Cl. G01C 21/32; G01C 21/34; G06F 16/29

(52) U.S. Cl. CPC G01C 21/32; G06F 16/29; G01C 21/3446

(57) ABSTRACT

A navigation data source is presented, which comprises: a first navigation data set (111) of a first type, wherein said first navigation data set (111) represents a map (M111) of a first geographic region (R111), wherein said first navigation data set (111) further defines a first gateway (G1), wherein said first gateway (G1) is associated with a position within said first geographic region (R111) and spaced from a border of said first geographic region (R1), and wherein said first gateway (G1) is associable with a gateway (G1) defined by a second navigation data set of a second type (121).

### FIELD

The invention relates to the field of navigation systems and more specifically to the definition of one or more gateways for linking navigation data sets representing maps of at least partially overlapping geographic regions.

### BACKGROUND

Both efficient map updating and efficient route computing are critical to modern navigation systems. In order to allow efficient map updating it is beneficial to divide the navigation data of the navigation system into navigation data sets which can be updated independently. For example, each navigation data set represents an independent map of a specific geographic region like a set of countries, a country, a set of states or a state. The smaller the geographic regions maps of which are represented by the navigation data sets, the more efficient the navigation data can be updated by updating only the navigation data set(s) representing the to be updated map(s). However, the more divided the navigation data of the navigation system into navigation data sets, the more navigation data sets have to be accessed for route computing which renders the route computing more complex.

### SUMMARY OF SOME EMBODIMENTS OF THE INVENTION

According to a first aspect of the invention, a navigation data source is presented, which comprises a first navigation data set of a first type, wherein the first navigation data set represents a map of a first geographic region, wherein the first navigation data set further defines a first gateway, wherein the first gateway is associated with a position within the first geographic region and spaced from a border of the first geographic region, and wherein the first gateway is associable with a gateway defined by a second navigation data set of a second type.

The navigation data source may be or may comprise any data source which is suitable for storing and/or transmitting navigation data. Examples of such a navigation data source are one or more files and/or one or more databases, in particular one or more files and/or one or more databases according to or at least partially compatible with the Navigation Data Standard (NDS) which is standardized by the NDS association. The website of the NDS association is presently available under the following link: http://www.nds-association.org.

For example, the navigation data source is a navigation database (e.g. a navigation database of a navigation device, e.g. a NDS database of a navigation device). The navigation database may comprise a first sub-database (e.g. a first NDS product database) for storing navigation data sets of the first type and a second sub-database (e.g. a second NDS product database) for storing navigation data sets of the second type. A navigation database may for example be a SQL (Structured Query Language) database (e.g. a SQLlite database). Alternatively or additionally, the navigation data source may be a navigation data file, for example a navigation data file for updating a navigation database of a navigation device (e.g. a NDS database of a navigation device). Example file formats for a navigation data file are the Physical Storage Format (PSF) as standardized by the NDS association, SQLlite data file format and/or Geographic Data Files (GDF) as standardized by the International Organization for Standardization (ISO, e.g. ISO GDF 4.0, formally referred to as IS014825:2004, or ISO GDF 5.0, formally referred to as IS014825:2011).

The navigation data source may comprise one or more navigation data sets, for example at least the first navigation data set.

A navigation data set (e.g. the first navigation data set and/or the second navigation data set) may comprise map data representing a map of a specific geographic region on earth (e.g. the first geographic region and/or the second geographic region). For example, the map data represents a two- or three-dimensional map of the specific geographic region on earth and/or a road map and/or a trail map of the specific geographic region on earth. Map data of a navigation data set (e.g. the first navigation data set and/or the second navigation data set) may be further partitioned into tile data sets, wherein each tile data set may represent a map of the intersection of a predetermined tile with the specific geographic region. For example, a geographical area such as the surface of the earth may sub-divided into predetermined tiles. The tiles are for example tiles of a regular or irregular grid and/or a geographic grid. Each tile may be associated with a tile identifier (e.g. an unique tile identifier). Accordingly, each tile data set may comprise the tile identifier of the tile a map of an intersection of which with the specific geographic region is represented by the tile data.

The map represented by a navigation data set may be an independent map, for example a map independent of maps represented by other navigation data sets of the navigation data source such that a navigation data set of the navigation data source may be updatable independently from other navigation data sets of the navigation data source. Accordingly, the geographic region a map of which is represented by a navigation data set may also be referred to as update region.

A navigation data set (e.g. the first navigation data set and/or the second navigation data set) may comprise gateway data defining one or more gateways (e.g. the first gateway defined by the first navigation data set and/or the gateway defined by the second navigation data set). For example, the gateway data may comprise a gateway table (e.g. a regional gateway table), wherein each entry of the gateway table at least partially defines one gateway.

A gateway (e.g. the first gateway defined by the first navigation data set and/or the gateway defined by the second navigation data set) may be defined by position information specifying the position associated with the gateway. The position associated with a gateway may be understood to be a geographic position. A geographic position may for example be defined by a tile identifier of the tile in which the position associated with the gateway is located and/or geographic coordinates such as a specific pairing of latitude and longitude in a Cartesian coordinate grid, a Spherical coordinate system, an ellipsoid-based system such as the World Geodetic System (WGS) or by coordinates of a global navigation satellite system (GNSS). Accordingly, the definition of a gateway (e.g. an entry in a gateway table) for example comprises geographic coordinates of the position associated with the gateway. Alternatively or additionally, a definition of a gateway (e.g. an entry in a gateway table) may comprise a tile identifier of the tile in which the position associated with the gateway is located and/or a gateway identifier (e.g. an unique gateway identifier).

A gateway (e.g. the first gateway defined by the first navigation data set) may be understood to be associable with another gateway (e.g. the gateway defined by the second navigation data set) if both gateways are associated with the same position (e.g. the same geographic position and/or the same tile). For example, a navigation data set may be linkable to another navigation data set by use of a gateway defined by the navigation data set which is associable with a gateway of the other navigation data set. A gateway may be associated with another gateway if the other gateway is identifiable as associated gateway. For example, the other gateway may be identified as associated gateway in a definition of the gateway (e.g. an entry in a gateway table). Alternatively or additionally, gateways may be identifiable as associated gateways by corresponding definitions of the gateways and/or corresponding entries in a gateway table, for example gateways may be identifiable as associated gateways if definitions of both gateways and/or entries for both gateways in a gateway table comprise the same gateway identifier and/or the same position information like a tile identifier and/or geographic coordinates.

As described above, associated gateways may form a link between two different navigation data sets representing two different maps (e.g. two independent maps) of at least partially adjacent and/or at least partially overlapping geographic regions. For example, associated gateways may form a routing link between a road network of a map of a geographic region represented by a navigation data set and a road network of a map of an at least partially adjacent and/or at least partially overlapping geographic region represented by another navigation data set.

Accordingly, the first navigation data set may be linkable to the second navigation data set by the first gateway which is associable with a gateway defined by the second navigation data set. The first gateway is associated with a position within the first geographic region and spaced from a border of the first geographic region. This may be understood to mean that the position associated with the first gateway is located within the first geographic region and spaced from a border of the first geographic position (i.e. it is not located on a border of the first geographic position). The first gateway associable with another gateway may thus define a potential routing link from a position within the first geographic region and spaced from a border of the first geographic region to a position associated with the gateway defined by the second navigation data set. This has for example the effect that the first navigation data set is linkable to the second navigation data set even if the second navigation data set represents a map of a sub-region and/or an overlapping region of the first geographic region which is entirely located within the first geographic region. Accordingly, the first gateway may serve for linking the first navigation data set to a navigation data set (e.g. the second navigation data set) representing a map of an at least partially overlapping geographic region of the first geographic region (e.g. a sub-region and/or a overlapping region of the first geographic region).

The routing link between associated gateways may be formed between the positions associated with these associated gateways. When a route is computed at least partially based on one of the navigation data sets defining one of these associated gateways and the route arrives at a position associated with the gateway defined by this navigation data set, the route may for example be continued at a position associated with the associated gateway defined by the other navigation data set and computing the route may be continued at least partially based on this other navigation data set. Thus, the navigation data set based on which a route is computed may be switched at a position associated with associated gateways. Navigation data sets representing differently optimized maps of at least partially overlapping geographic regions may accordingly be used for computing different portions of a route. In the same geographic region, it may thus be switched between different navigation data sets, for example different navigation data sets representing maps having different level of details or being optimized for different computing requirements.

For example, the first navigation data set may be optimized for efficiently computing long-distance routes in the first geographic region and the second navigation data set may be optimized for efficiently computing short distance routes in a (smaller) second geographic region (e.g. the second geographic region as described below). In this example, the second navigation data set may cover the starting region and/or the destination region of the route such that a short-distance portion of the route in the starting region and/or the destination region may be computed based on the second navigation data set, and a long-distance portion of the route may be computed based on the first navigation data set.

In the following, the features of exemplary embodiments according to the first aspect of the invention are described by way of examples.

According to an exemplary embodiment of the first aspect of the invention, the second navigation data set represents a map of a second geographic region, wherein the second geographic region is a sub-region of the first geographic region and/or an overlapping region of the first geographic region. An overlapping region (e.g. the second geographic region) of a geographic region (e.g. the first geographic region) may be understood to be a region which at least partially overlaps the geographic region. For example, a sub-region of a geographic region (e.g. the second geographic region) is located entirely or at least partially within the geographic region (e.g. the first geographic region). A sub-region of a geographic region (e.g. the second geographic region) may be smaller than the geographic region and may be entirely overlapped by the geographic region (e.g. the first geographic region).

The gateway defined by the second navigation data set may be associated with a position within the second geographic region and/or at a border of the second geographic region. In other words, the position associated with the gateway defined by the second navigation data is for example located within the second geographic region and/or on or at a border of the second geographic region.

According to an exemplary embodiment of the first aspect of the invention, the first gateway defined by the first navigation data set and the gateway defined by the second navigation data set are associated with the same position (e.g. the same geographic position). For example, the position which is associated with both the first gateway defined by the first navigation data set and the gateway defined by the second navigation data set is within the first geographic region and spaced from a border of the first geographic region; and it is within the second geographic region and/or at a border of the second geographic region. Accordingly, a routing link may be formed between the first and the second navigation data set by associating these gateways enabling computing a continuous route via the routing link at least partially based on the first navigation data set and at least partially based on the second navigation data set.

According to an exemplary embodiment of the first aspect of the invention, the first gateway defined by the first navigation data set is associated with the gateway defined by the second navigation data set. As described above, a routing link may be formed between the first navigation data set and the second navigation data set by associating the first gateway defined by the first navigation data set and the gateway defined by the second navigation data set.

For example, the first gateway may be associated with the gateway defined by the second navigation data set by identifying or referring to the gateway defined by the second navigation data set as associated gateway in the definition of the first gateway (e.g. an entry in a regional gateway table of the first navigation data set); and the gateway defined by the second navigation data set may be associated with the first gateway by identifying or referring to the first gateway as associated gateway in the definition of the gateway defined by the second navigation data set (e.g. an entry in a regional gateway table of the second navigation data set). Therein, a gateway may be identified or referred to by its gateway identifier.

Alternatively or additionally, the first gateway defined by the first navigation data set may be associated with the gateway defined by the second navigation data set by corresponding entries in one or more gateway tables identifying both gateways as associated gateways. For example, the navigation data source may comprise global gateway data maintaining one or more global gateway tables. The first gateway defined by the first navigation data set and the gateway defined by the second navigation data may be associated by corresponding entries in the one or more global gateway tables. For example, each of the corresponding entries may comprise the same gateway identifier and/or the same position information like a tile identifier and/or geographic coordinates.

According to an exemplary embodiment of the first aspect of the invention, the navigation data source further comprises the second navigation data set. As described above, the navigation data source may be a navigation database comprising a first sub-database (e.g. a first NDS product database) for storing navigation data sets of the first type and a second sub-database (e.g. a second NDS product database) for storing navigation data sets of the second type. Accordingly, the first navigation data set may be stored in the first sub-database and the second navigation data set may be stored in the second sub-database.

According to an exemplary embodiment of the first aspect of the invention, the first gateway is one of a first set of gateways defined by the first navigation data set, wherein each gateway of the first set of gateways is associated with a position within the first geographic region and spaced from a border of the first geographic region, and wherein each gateway of the first set of gateways is associable with a gateway defined by the second navigation data set or another navigation data set of the second type.

According to an exemplary embodiment of the first aspect of the invention, the first navigation data set further defines a second gateway, wherein the second gateway is associated with a position at a border of the first geographic region, and wherein the second gateway is associable with a gateway defined by a third navigation data set of the first type. The first gateway is associated with a position at a border of the first geographic region. This may be understood to mean that the position associated with the second gateway is located at or on a border of the first geographic position (i.e. it is not located spaced from a border of the first geographic position). The position associated with the second gateway may be understood to be a geographic position.

According to an exemplary embodiment of the first aspect of the invention, the third navigation data set represents a map of a third geographic region, wherein the third geographic region is an adjacent region of the first geographic region. For example, adjacent geographic regions (e.g. the first and the third geographic region) may at least partially share a border, but may not overlap each other.

The gateway defined by the third navigation data set may be associated with a position at a border of the third geographic region. In other words, the position associated with the gateway defined by the third navigation data is for example located on or at a border of the third geographic region.

According to an exemplary embodiment of the first aspect of the invention, the second gateway defined by the first navigation data set and the gateway defined by the third navigation data set are associated with the same position. The position which is associated with the second gateway defined by the first navigation data set and the gateway defined by the third navigation data set may be at a border of the first geographic region and at a border of the third geographic region (e.g. the position may be at a shared border section of the first geographic region and the third geographic region). Accordingly, a routing link may be formed between the first and the third navigation data set by associating these gateways enabling computing a continuous route via the routing link at least partially based on the first navigation data set and at least partially based on the third navigation data set.

According to an exemplary embodiment of the first aspect of the invention, the second gateway defined by the first navigation data set is associated with the gateway defined by the third navigation data set. As described above, a routing link may be formed between the first navigation data set and the third navigation data set by associating the second gateway defined by the first navigation data set and the gateway defined by the third navigation data set. The second gateway may be associated with the gateway defined by the third navigation data set in a similar manner as described above with respect to the first gateway and the gateway defined by the second navigation data set.

According to an exemplary embodiment of the first aspect of the invention, the navigation data source further comprises the third navigation data set. As described above, the navigation data source may be a navigation database comprising a first sub-database (e.g. a first NDS product database) for storing navigation data sets of the first type and a second sub-database (e.g. a second NDS product database) for storing navigation data sets of the second type. Accordingly, the first navigation data set and the third navigation data set may be stored in the first sub-database and the second navigation data set may be stored in the second sub-database.

According to an exemplary embodiment of the first aspect of the invention, the second gateway is one of a second set of gateways defined by the first navigation data set, wherein each gateway of the second set of gateways is associated with a position at a border of the first geographic region, and wherein each gateway of the second set of gateways is associable with a gateway defined by the third navigation data set or another navigation data set of the first type.

According to an exemplary embodiment of the first aspect of the invention, a level of detail of the map represented by the first navigation data set is lower than a level of detail of the map represented by the second navigation data set. For example, a level of detail of the maps represented by the navigation data sets of the first type is lower than a level of detail of the maps represented by the navigation data sets of the second type.

The level of detail of a map (e.g. the map represented by the first navigation data set) may be understood to be lower than the level of detail of another map (e.g. the map represented by the second navigation data set) if the map contains fewer details than the other map (i.e. the other map contains additional details such as additional roads, additional point of interests, etc.). For example, the map represented by the second navigation data set (or the maps represented by the navigation data sets of the second type) is (are) fully fledged; and the map represented by the first navigation data set (or the maps represented by the navigation data sets of the first type) is (are) thinned out.

For example, the map represented by the first navigation data set contains a first selection of roads and the map represented by the second navigation data set contains a second selection of roads. The first selection of roads may comprise only main roads such as motorways, highways, expressways, major roads, etc. The second selection of roads may comprise both main roads and side roads (e.g. residential roads). In certain exemplary embodiments of the first aspect of the invention, the roads of the first selection of roads may be optimized for computing long-distance routes in the first geographic region; and the roads of the second selection of roads may be optimized for computing short-distance routes in the second geographic region.

For example, the second selection of roads may contain each road of the first selection of roads which is located in the second geographic region and at least one additional road. In this example, the map represented by the first navigation data set has a lower level of detail (e.g. is thinned out) than the map (e.g. a fully-fledged map) represented by the second navigation data set.

Alternatively or additionally, the level of detail of a map (e.g. the map represented by the first navigation data set) may be understood to be lower than the level of detail of another map (e.g. the map represented by the second navigation data set) if the map has a larger scale (e.g. a larger map scale) and/or a lower accuracy (e.g. the navigation data set representing the map has a lower data accuracy) and/or a lower resolution (e.g. the navigation data set representing the map has a lower data resolution) and/or a lower density (e.g. the navigation data set representing the map has a lower data density) than the other map. A map scale may describe the ratio of a distance on the map to the corresponding distance on the ground. A data accuracy of a navigation data set representing a map may describe the variance of a position of an object on the map and the actual geographic position of the object. A data resolution of a navigation data set representing a map may describe the smallest difference between adjacent geographic positions that are recorded and/or recordable in the navigation data set. A data density of a navigation data set representing a map may describe the ratio of the amount of data contained in the navigation data set per unit area of the specific geographic region a map of which is represented by the navigation data set.

According to an exemplary embodiment of the first aspect of the invention, the navigation data source further comprises a plurality of navigation data sets of the first type, wherein the first navigation data set is one of the plurality of navigation data sets of the first type. For example, the plurality of navigation data sets of the first type represents a first plurality of independent maps of at least partially adjacent geographic regions, wherein each navigation data set of the plurality of navigation data sets of the first type represents one specific map of a specific geographic region of the first plurality of independent maps of at least partially adjacent geographic regions. In this example, a geographic area (e.g. the surface of the earth, a continent such as Europe or North-America, etc.) may be sub-divided into the at least partially adjacent geographic regions (e.g. countries, states, etc.) maps of which are represented by the plurality of navigation data sets of the first type.

According to an exemplary embodiment of the first aspect of the invention, the navigation data source further comprises a plurality of navigation data sets of the second type, wherein the second navigation data set is one of the plurality of navigation data sets of the second type.

For example, the plurality of navigation data sets of the second type represents a second plurality of independent maps of at least partially adjacent sub-regions and/or overlapping regions of the first geographic region, wherein each navigation data set of the plurality of navigation data sets of the second type represents one specific map of the second plurality of independent maps of at least partially adjacent sub-regions and/or overlapping regions of the first geographic region. In this example, the first geographic region (e.g. a country, a state, etc.) may be sub-divided into the at least partially adjacent geographic regions (e.g. counties, districts, cities, etc.) maps of which are represented by the plurality of navigation data sets of the seconds type.

Alternatively or additionally, the plurality of navigation data sets of the second type may represent a second plurality of independent maps of at least partially adjacent sub-regions and/or overlapping regions of the first geographic region and one or more further geographic regions a map of which is represented by the plurality of navigation data sets of the first type, wherein each navigation data set of the plurality of navigation data sets of the second type may then represent one specific map of the second plurality of independent maps of at least partially adjacent sub-regions and/or overlapping regions of these geographic regions. In this example, a geographic area covered by these geographic regions (e.g. the surface of the earth, a continent such as Europe or North-America, etc.) may be sub-divided into the at least partially adjacent geographic regions (e.g. counties, districts, cities, etc.) maps of which are represented by the plurality of navigation data sets of the first type.

In certain exemplary embodiments of the first aspect of the invention, the maps represented by the plurality of navigation data sets of the first type and the maps represented by the plurality of navigation data sets of the second type may cover the same geographic area, wherein the geographic regions of the maps represented by the plurality of navigation data sets of the second type are smaller than and/or sub-regions of the geographic regions of the maps represented by the plurality of navigation data sets of the first type.

According to an exemplary embodiment of the first aspect of the invention, a storage medium is presented, which comprises the navigation data source. The storage medium may be a tangible storage medium, for example a tangible computer-readable storage medium. The storage medium may be a storage medium of a navigation device and/or for a navigation device, for example a navigation device according to the second aspect of the invention.

According to an exemplary embodiment of the first aspect of the invention, a method is presented, which comprises providing the navigation data source according to the first aspect of the invention. For example, the navigation data source may be provided by a server to a navigation device. Providing the navigation data source to the navigation device may for example be understood to mean that the navigation data source is sent or triggered to be sent to the navigation device. For example, the navigation data source is sent or triggered to be sent by the server in a signal or as part of a signal (e.g. a network and/or radio signal). The navigation data source may for example be sent by transmitting the navigation data source in such a signal or as part of such a signal by transmitting means of the server, for example a communication interface such as a network interface and/or radio interface (e.g. a transmitter and/or a transceiver). In certain exemplary embodiments of the first exemplary aspect of the invention, the signal may be a cellular radio signal or a Bluetooth radio signal or a wireless local area network (WLAN) signal. Alternatively or additionally, providing the navigation data source to the navigation device may for example be understood to mean that the navigation data source is made accessible to and/or retrievably by the navigation device, for example accessibly and/or retrievably stored in memory means (e.g. a storage medium) of the server.

According to an exemplary embodiment of the first aspect of the invention, a computer program code is presented, the computer program code when executed by a processor causing an apparatus to perform the actions of the method of the first aspect of the invention.

According to an exemplary embodiment of the first aspect of the invention, a server is presented, which comprises means for performing the method according to the first aspect of the invention. The means of the server may be implemented in hardware and/or software. They may comprise for instance at least one processor for executing computer program code for realizing the required functions, at least one memory storing the program code, or both. Alternatively, they could comprise for instance circuitry that is designed to realize the required functions, for instance implemented in a chipset or a chip, like an integrated circuit. In general, the means may comprise for instance one or more processing means such as a processor and a memory. Optionally, the server may comprise various other components, like a communication interface, a network interface, a radio interface, a data interface, a user interface etc.

For example, the server comprises at least one processor and at least one memory including computer program code, the at least one memory and the computer program code configured to, with the at least one processor, cause an apparatus at least to perform at least partially the method and/or the steps of the method according to the first aspect of the invention.

The server may be a server of a system according to the third aspect of the invention.

According to a second aspect of the invention, a method is presented, which comprises:
storing and/or receiving the navigation data source according to the first aspect of the invention;
receiving a routing request for computing a route, wherein the routing request at least defines a starting position and a destination position for the route;
computing the route and/or causing computing the route at least partially based on the routing request and the navigation data source, wherein the computed route includes the position of the first gateway; and
providing the computed route.

For example, the method is performed by a navigation device according to the second aspect of the invention.

Receiving the navigation data source may be understood to mean that the navigation data source is received in a signal or as part of a signal (e.g. a network and/or radio signal). The navigation data source may for example be received in such a signal or as part of such a signal by receiving means of the navigation device, for example a communication interface such as a network interface and/or radio interface (e.g. a receiver and/or a transceiver). In certain exemplary embodiments of the second aspect of the invention, the signal may be a cellular radio signal or a Bluetooth radio signal or a wireless local area network (WLAN) signal. Alternatively or additionally, receiving the navigation data source may for example be understood to mean that the navigation data source is made accessible to and/or retrievable by the navigation device, for example by receiving a storage medium comprising the navigation data source in storage medium reading means of the navigation device (e.g. a storage medium interface such as a storage medium drive or a storage medium connector).

Storing the navigation data source may for example be understood to mean that the navigation data source is stored in memory means (e.g. a storage medium) of the navigation device.

A routing request may be received by receiving user input on the navigation device. For example, the routing request is received by user input means of the navigation device (e.g. a user interface such as a touch sensitive display, a key, a keyboard or a touchpad). Alternatively or additionally, the routing request may be received in a signal or as part of a signal (e.g. a network and/or radio signal), for example by receiving means of the navigation device such as a communication interface as described above. For example, the routing request may comprise an address and/or geographic coordinates as starting position and/or as destination position.

Causing computing the route may be understood to mean that a request for computing the route is transmitted to a server (e.g. the server of the first and/or third aspects of the invention) such that the server is caused to compute the route at least partially based on the routing request and the navigation data source. Subsequently, the computed route may be received at the navigation device from the server.

Computing the route at least partially based on the routing request and the navigation data source may be understood to mean that a route from the starting position to the destination position is computed at least partially based on the navigation data comprised in the navigation data source (e.g. the first navigation data set and/or the second navigation data set). For example, the route may be computed by the navigation device. Alternatively, the route may be computed by the server as described above.

Providing the computed route may for example be understood to mean that the computed route is provided for displaying and/or for navigating along the computed route. For example, the route may be provided by causing display of the route or of a portion of the route (e.g. on displaying means of the navigation device such as a user interface) and/or by causing navigating along the computed route.

According to an exemplary embodiment of the second aspect of the invention, the starting position and/or the destination position are within the second geographic region, wherein the computing the route is at least partially based on the first navigation data set and at least partially based on the second navigation data set. Accordingly, the second geographic region may be the starting region (i.e. within which the starting position is located) and/or the destination region (i.e. within which the destination position is located).

For example, at least a first portion of the route from the starting position to the destination position is computed based on the first navigation data set, and a second portion of the route is computed based on the second navigation data set. In this example, the first portion of the route and the second portion of the route may be linked via a routing link formed between the first gateway defined by the first navigation data set and the gateway defined by the second navigation data set. Accordingly, the first portion of the route and the second portion of the route may meet each other at the position associated with the first gateway defined by the first gateway such that the route may include this position.

According to an exemplary embodiment of the second aspect of the invention, a computer program code is presented, the computer program code when executed by a processor causing an apparatus to perform the actions of the method of the second aspect of the invention.

According to an exemplary embodiment of the second aspect of the invention, a navigation device is presented, which comprises means for performing the method according to the second aspect of the invention. The means of the navigation device may be implemented in hardware and/or software. They may comprise for instance at least one processor for executing computer program code for realizing the required functions, at least one memory storing the program code, or both. Alternatively, they could comprise for instance circuitry that is designed to realize the required functions, for instance implemented in a chipset or a chip, like an integrated circuit. In general, the means may comprise for instance one or more processing means such as a processor and a memory. Optionally, the navigation device may comprise various other components, like a communication interface, a network interface, a radio interface, a data interface, a user interface etc.

For example, the navigation device comprises at least one processor and at least one memory including computer program code, the at least one memory and the computer program code configured to, with the at least one processor, cause an apparatus (e.g. the navigation device) at least to perform at least partially the method and/or the steps of the method according to the second aspect of the invention.

The navigation device is for example an GNSS-enabled smartphone and/or a navigation device of a vehicle (e.g. an automotive navigation device and/or a car navigation device).

According to a third aspect of the invention, a navigation system is presented, which comprises:
a navigation device according to the second aspect of the invention; and
a server according to the first aspect of the invention.

For example, the navigation system is a hybrid navigation system in which one or more navigation data sets of the plurality of navigation data sets of the first type (e.g.

the first navigation data set) is cached and/or permanently stored on the navigation device and one or more navigation data sets of the plurality of navigation data sets of the second type (e.g. the second navigation data set) is received at the navigation device from the server if required for computing a route and/or for navigating along a computed route and/or for displaying a computed route.

In a hybrid navigation system, the one or more navigation data sets of the plurality of navigation data sets of the second type first navigation data set (e.g. the first navigation data set) cached and/or permanently stored on the navigation device may be updated on a regular or irregular basis. They are for example used for finding a destination position of a routing request and/or for identifying the one or more navigation data sets of the plurality of navigation data sets of the second type (e.g. the second navigation data set) to be requested from the server. Furthermore, the one or more navigation data sets of the plurality of navigation data sets of the second type first navigation data set (e.g. the first navigation data set) may be used as fallback solution for computing a route if no communication connection to the server is available.

If a communication connection to the server is available, the navigation device for example transmits a request for the one or more navigation data sets of the plurality of navigation data sets of the second type (e.g. the second navigation data set) to the server. For example, each of the requested navigation data sets (e.g. the second navigation data set) represents a map of a geographic region touched and/or crossed by the route such as the starting region and/or the destination region of the route. In response to this request, the server may transmit the requested navigation data set(s) (e.g. the second navigation data set) to the navigation device. Subsequently the navigation device may compute the route at least partially based on the first navigation data set and the requested navigation data set(s) of the second type (e.g. the second navigation data set). Accordingly, always up-to date navigation data set(s) of the second type may be provided to the navigation device for partially or completely computing the route.

Alternatively or additionally, the navigation device for example transmits a request for computing the route to the server if a communication connection to the server is available. In response to this request, the server may compute the route at least partially based on one or more navigation data sets of the plurality of navigation data sets of the second type (e.g. the second navigation data set) and, subsequently, transmit the computed route together with the one or more navigation data sets of the plurality of navigation data sets of the second type (e.g. the second navigation data set) to the navigation device. The navigation device may then use the one or more navigation data sets of the plurality of navigation data sets of the second type (e.g. the second navigation data set) for navigating along the computed route and/or for displaying the computed route. Accordingly, only navigation data set(s) of the second type which are touched and/or crossed by the route may be received at the navigation device.

In certain exemplary embodiments of the third aspect of the invention, it may be beneficial if the navigation data sets of the plurality of navigation data sets of the first type (e.g. the first navigation data set) represent independent maps of larger geographic regions and with a lower level of detail than the navigation data sets of the plurality of navigation data sets of the second type (e.g. the second navigation data set).

On the one hand, it may help to save data volume for communicating the one or more navigation data sets of the plurality of navigation data sets of the second type (e.g. the second navigation data set) from the server to the navigation device low, if the one or more navigation data sets of the plurality of navigation data sets of the second type (e.g. the second navigation data set) represent maps of small(er) geographic regions. On the other hand, computing and/or displaying a route based on a lot of navigation data sets representing maps of small(er) geographic regions is less efficient than based on navigation data sets representing maps of large(r) geographic regions. Thus, the performance may be increased by using one or more of the navigation data sets of the plurality of navigation data sets of the first type representing maps of large(r) geographic regions for computing and/or displaying long-distance portions of a route. The lower level of detail of the maps represented by the navigation data sets of the plurality of navigation data sets of the first type may help to save storage capacity of memory means (e.g. a storage medium) of the navigation device.

The features and example embodiments of the invention described above may equally pertain to the different aspects according to the present invention.

It is to be understood that the presentation of embodiments of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a block diagram of an exemplary embodiment of a navigation data source according to the first aspect of the invention;

FIG. 2a-2d are exemplary maps of geographic regions represented by navigation data sets of the navigation data source of FIG. 1;

FIG. 3a shows an exemplary combination of the maps of FIGS. 2a-2d and a grid sub-dividing the geographic area covered by these maps into predetermined tiles;

FIGS. 3b-3g show exemplary gateway tables of the navigation data sets and sub-databases of the navigation data source of FIG. 1;

FIG. 4a is a block diagram of an exemplary embodiment of a server according to the first aspect of the invention;

FIG. 4b is a block diagram of an exemplary embodiment of a navigation device according to the second aspect of the invention;

FIG. 4c is a block diagram of an exemplary embodiment of a navigation system according to the third aspect of the invention;

FIG. 5 is a flowchart of an exemplary embodiment of a method according to the second aspect of the invention;

FIG. 6 shows an exemplary route computed based on the maps of FIGS. 2a-2d;

FIG. 7 is a schematic illustration of examples of tangible storage media according to the present invention.

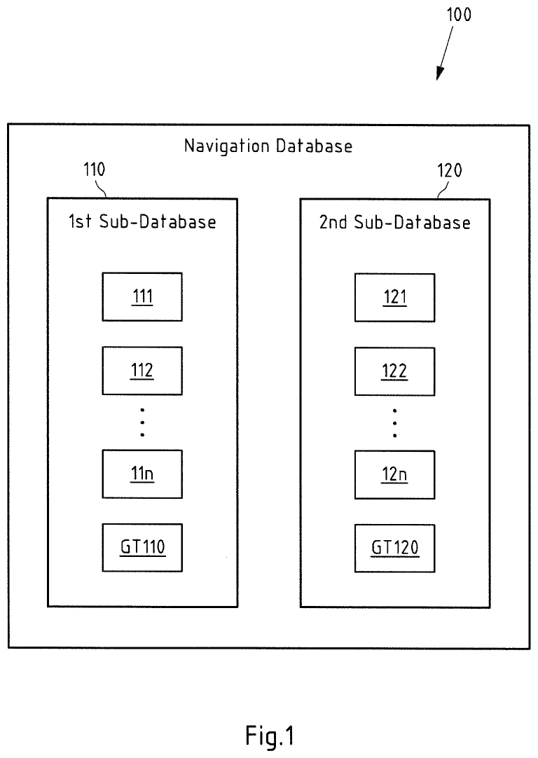

FIG. 1 is a block diagram of an exemplary embodiment of a navigation data source according to the first aspect of the invention. In FIG. 1, the navigation data source is depicted as navigation database 100. The navigation database 100 may be relational database (e.g. a SQL database) comprising (e.g. storing) one or more navigation data sets. For example, the navigation database 100 is a NDS navigation database (i.e. a navigation database according to the NDS standard or at least partially compatible with the NDS standard). Each navigation data set of the navigation database 100 may comprise map data representing a map of a specific geographic region and gateway data defining one or more gateways. The navigation data sets of the navigation database 100 may be independently updatable.

The navigation database 100 comprises a first sub-database 110 (e.g. a first NDS product database) for storing navigation data sets of a first type. The first sub-database 110 comprises a first navigation data set 111 of the first type. This navigation data set 111 is an exemplary embodiment of the first navigation data set of the first type according to the first aspect of the invention.

Optionally, navigation database 100 may comprise a second sub-database 120 (e.g. a second NDS product database) for storing navigation data sets of a second type. The optional second sub-database 120 comprises a second navigation data set 121 of the second type. The optional second navigation data set 121 is an exemplary embodiment of the second navigation data set of the second type according to the first aspect of the invention.

In certain embodiments of the first aspect of the invention, the first sub-database 110 may comprise a plurality of navigation data sets of the first type; and the second sub-database 120 may comprise a plurality of navigation data sets of the second type. For example, the first sub-database 110 comprises optional navigation data sets 112 to 11n of the first type; and the second sub-database 120 comprises optional navigation data sets 122 to 12n of the second type. The optional third navigation data set 112 is an exemplary embodiment of the third navigation data set of the first type according to the first aspect of the invention.

Furthermore, the first sub-database 110 and the second sub-database 120 may comprise global gateway table GT110 and global gateway table GT120, respectively.

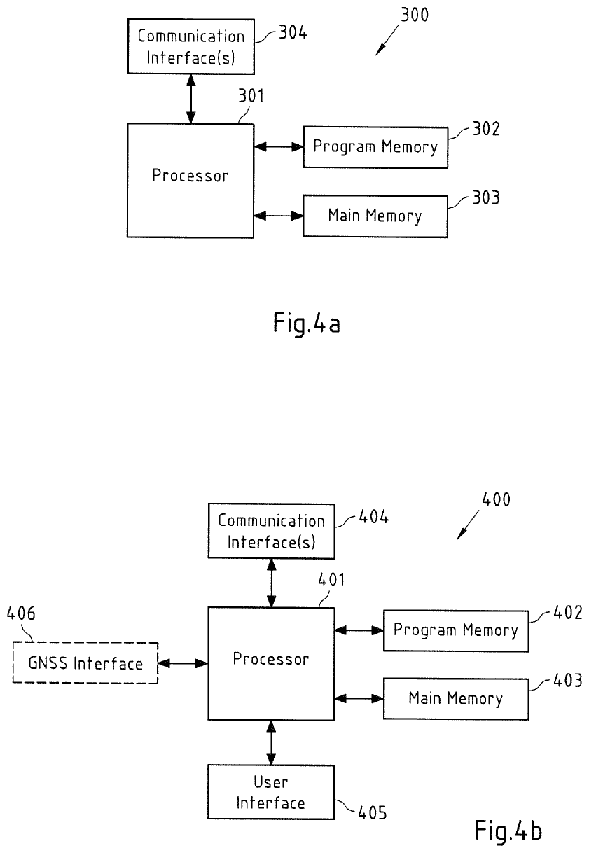

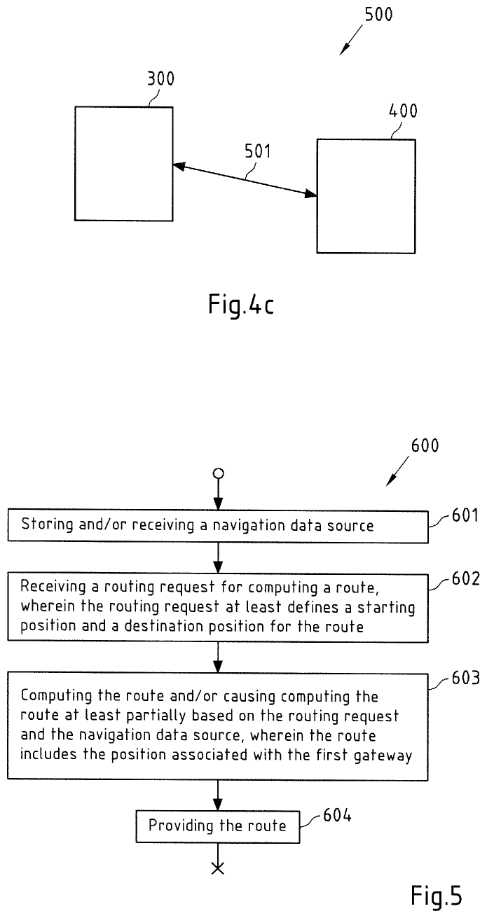

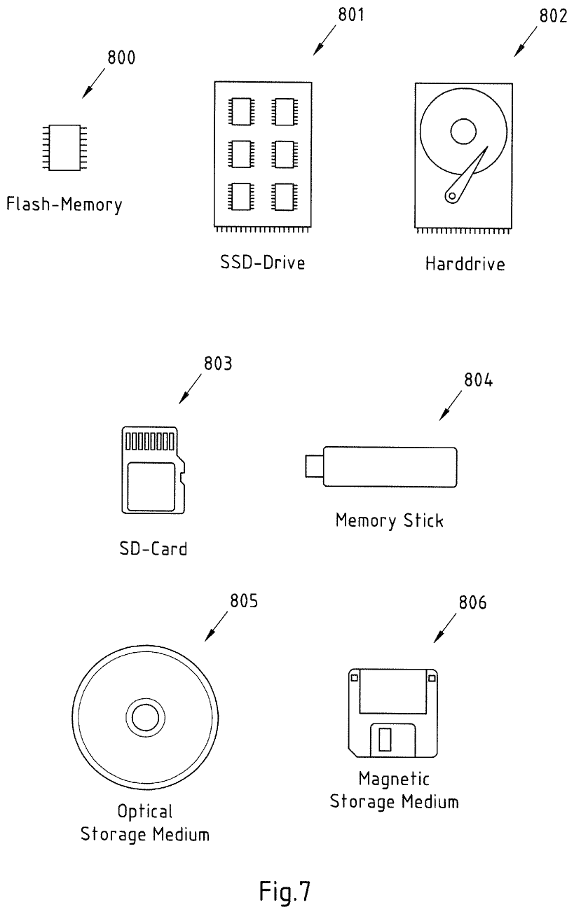

The navigation database 100 may be stored on a storage medium (see FIG. 7) and/or in program memory 402 of navigation device 400 (see FIG. 4b).

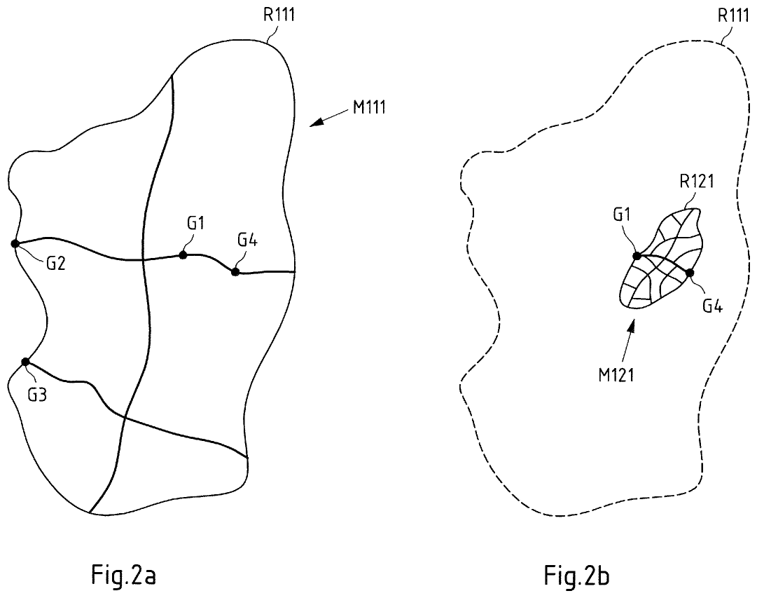

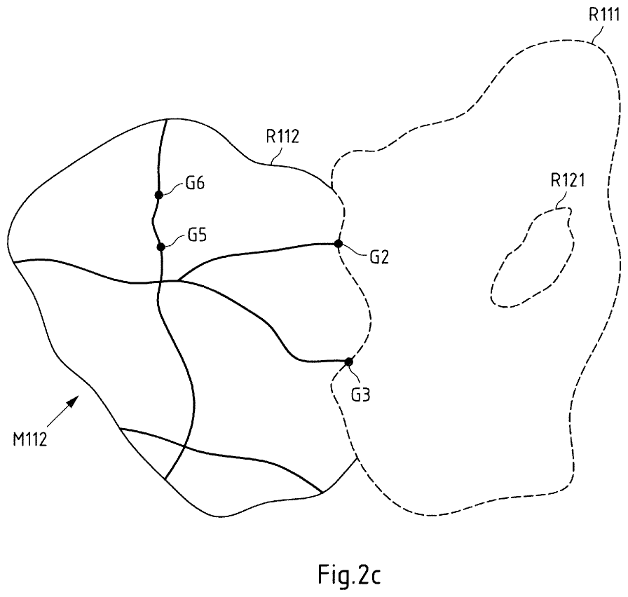

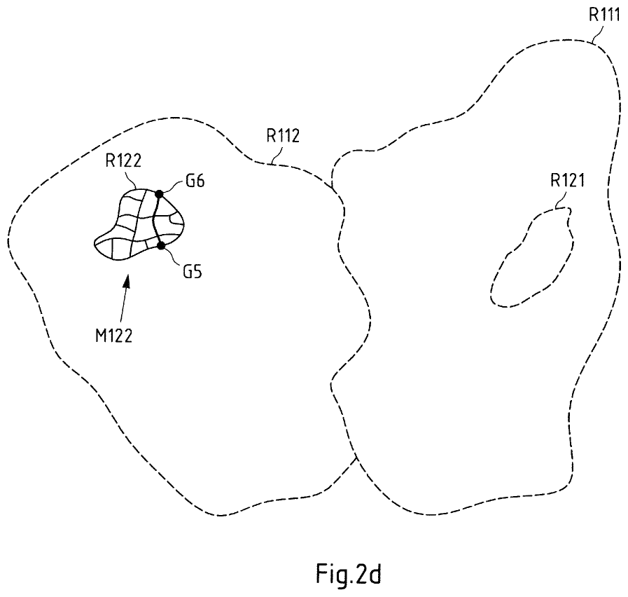

FIGS. 2a to 2d are exemplary maps M111, M112, M121 and M122 of geographic regions represented by navigation data sets of navigation database 100 as described above with respect to FIG. 1. In the following it is assumed that the first navigation data set 111 represents map M111 of a first geographic region R111, the second navigation data set 121 represents a map M121 of a second geographic region R121, the third navigation data set 112 represents map M112 of a third geographic region R112, and the fourth navigation data set 122 represents map M122 of a fourth geographic region R122.

Geographic regions R111, R112, R121 and R122 are for example geographic regions on earth. The first and third geographic regions R111 and R112 are adjacent geographic regions at least partially sharing a border, but not overlapping each other.

The second geographic region R121 is a sub-region of the first geographic region R111 which entirely overlaps the first geographic region R111; and the fourth geographic region R122 is a sub-region of the third geographic region R112 which entirely overlaps the third geographic region. The geographic regions R111, R112, R121 and R122 as depicted in FIGS. 2a to 2d are only exemplary and to be understood to be non-limiting. In another embodiment according to the invention, the second geographic region and/or the fourth geographic region may for example be overlapping regions of the first geographic region and/or the third geographic region which only partially overlap the first geographic region and/or the third geographic region.

In FIGS. 2a to 2d, maps M111, M112, M121 and M122 are depicted as road maps. However, they are not not limited to road maps and may alternatively or additionally be two- or three-dimensional maps and/or trail maps.

In certain embodiments of the first aspect of the invention, the navigation data sets of the first type represent maps with a lower level of detail than the navigation data sets of the second type. As described above, the level of detail of a map may be understood to be lower than the level of detail of another map if the map contains fewer details than the other map. In FIGS. 2a to 2d, maps M111 and M112 have for example a lower level of detail than maps M121 and M122, because the road networks represented by maps M121 and M122 contain additional roads.

As shown in FIGS. 2a to 2d, each of the navigation data sets 111, 112, 121 and 122 may define one or more of gateways G1 to G6. A gateway is for example defined by specifying the position associated with the gateway and a gateway identifier. In this respect, it is noted that gateways G1 to G6 the associated positions of which are indicated in FIGS. 2a to 2d are only exemplary.

The first navigation data set 111 defines a first gateway G1. As indicated in FIG. 2a, the position associated with the first gateway G1 is within the first geographic region R111 and spaced from the border of the first geographic region R111. The first gateway G1 defined by the first navigation data set 111 is an example embodiment of the first gateway according to the first aspect of the invention.

According to certain embodiments of the first aspect of the invention, the first navigation data set 111 may define one or more further gateways such as gateways G2, G3 and G4 as exemplary shown in FIG. 2a. The position associated with the second gateway G2 is at the border of the first geographic region R111. The second gateway G2 defined by the first navigation data set 111 is an example embodiment of the second gateway according to the first aspect of the invention.

Gateways G1 and G4 may be or may be part of a first set of gateways defined by the first navigation data set 111, wherein each gateway of the first set of gateways is associated with a position within the first geographic region R111 and spaced from the border of the first geographic region R111. Gateways G2 and G3 may be or may be part of a second set of gateways defined by the first navigation data set 111, wherein each gateway of the second set of gateways is associated with a position at the border of the first geographic region R111.

Each of the gateways G1, G2, G3 and G4 defined by the first navigation data set 111 may be associable with a gateway defined by another navigation data set (e.g. one of navigation data sets 112, 121 and 122).

Gateways having the same reference signs depicted in FIGS. 2a to 2d are exemplary associated with the same position. For example, the position associated with gateway G1 defined by the second navigation data set 121 corresponds to the position associated with the first gateway G1 defined by the first navigation data set 111 (see FIGS. 2a and 2b); and the position associated with gateway G2 defined by the third navigation data set 112 corresponds to the position associated with the second gateway G2 defined by the first navigation data set 111 (see FIGS. 2a and 2c).

In certain exemplary embodiments of the first aspect of the invention, gateways may be understood to be associable if they are associated with the same position. Accordingly, gateways having the same reference signs depicted in FIGS. 2a to 2d may be understood to be associable gateways.

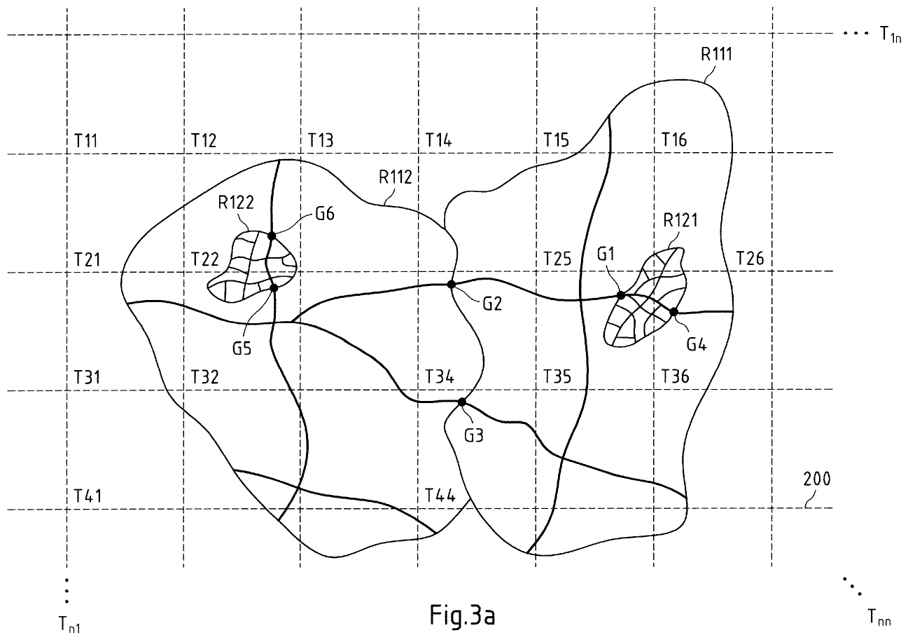

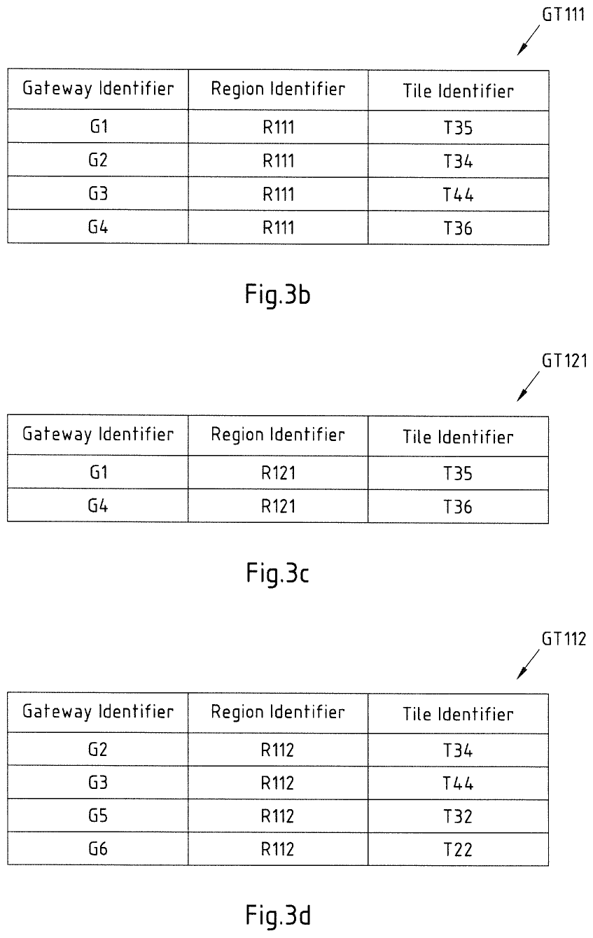

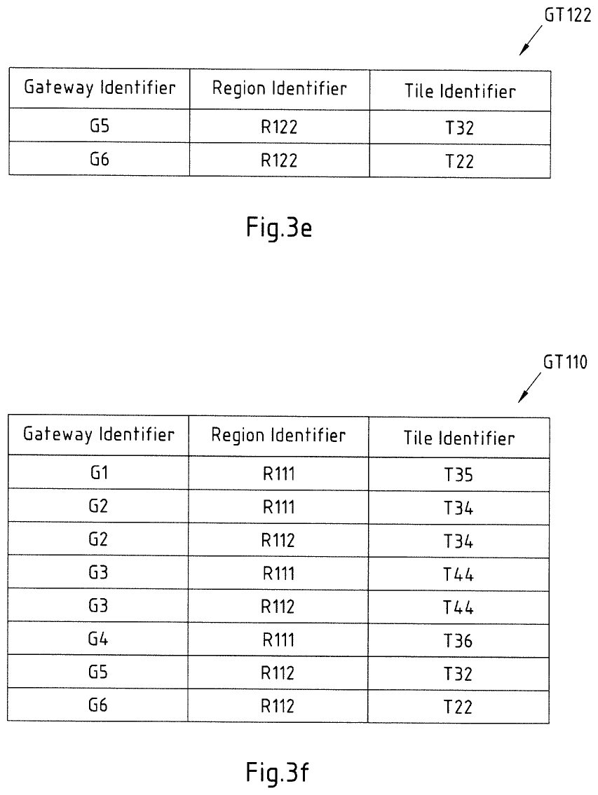

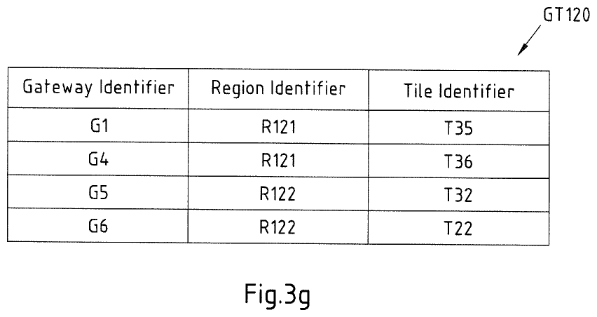

FIG. 3a shows an exemplary combination of maps M111, M112, M121 and M122 of geographic regions R111, R112, R121 and R122 represented by navigation data sets 111, 112,121, 122 as described above with respect to FIGS. 2a to 2d. Furthermore, FIG. 3a shows a grid 200 sub-dividing the geographic area covered by maps M111, M112, M121 and M122 into predetermined tiles. For example, grid 200 logically sub-divides the surface of the earth into predetermined tiles. As shown in FIG. 3a, each tile of grid 200 is associated with a tile identifier T11 to Tnn.

The tiles and/or the corresponding tile identifiers may be used for accessing navigation data and/or for referencing navigation data. For this purpose, the map data of the navigation data sets of navigation data source 100 (e.g. navigation data sets 111, 112,121, 122) may be partitioned into tile data sets, wherein each tile data set represents the intersection of a predetermined tile of grid 200 with the map represented by the respective navigation data sets. Each tile data set may comprise a tile identifier of the respective tile. For example, tiles T25, T26, T35 and T36 of grid 200 at least partially intersect with map M121. Accordingly, the map data of the second navigation data set 121 representing map M121 may be partitioned into four corresponding tile data sets comprising the tile identifier of the respective tile (i.e. one of tiles T25, T26, T35 and T36).

Furthermore, the gateway data of the navigation data sets of navigation data source 100 (e.g. navigation data sets 111, 112,121, 122) may comprise regional gateway tables for defining one or more gateways.

Exemplary gateway tables GT111, GT112, GT121 and GT122 of navigation data sets 111, 112,121 and 122, respectively, are shown in FIGS. 3b to 3e. Each entry in gateway tables GT111, GT112, GT121 and GT122 at least partially defines a gateway defined by the respective navigation data set. Furthermore, the first sub-database and the second sub-database may each comprise a global gateway table GT110/GT120. Exemplary global gateway tables GT110 and GT120 of sub-databases 110 and 120, respectively, are shown in FIGS. 3f and 3g. Each entry in global gateway tables GT110 and GT120 identifies a gateway defined by one navigation data set stored in the respective sub-database.

For example, each entry in a gateway table (e.g. regional gateway tables GT111, GT112, GT121 and GT122 and global gateway tables GT110 and GT120) comprises an identifier of the gateway, a region identifier of the geographic region a map of which is represented by the navigation data set and a tile identifier of the tile in which the position associated with the gateway is located. Gateway table GT111 of the first navigation data set 111, for example, comprises an entry for the first gateway G1 with the region identifier of geographic region R111 and the tile identifier of tile T35. Global gateway table GT110 comprises a corresponding entry.

Global gateway tables GT110 and GT120 may be used as routing tables when computing a route based on the navigation database 100. For example, a routing link may be formed between two gateways defined by different navigation data sets having entries in one of the global gateway tables GT110 and GT120 with the same gateway identifier and/or the same tile identifier. Accordingly, two gateways defined by different navigation data sets being identified by corresponding entries in one of the global gateway tables GT110 and GT120 with the same gateway identifier and/or the same tile identifier may be understood to be associated gateways. When a route is computed at least partially based on a navigation data set and the route arrives at a position associated with a gateway defined by this navigation data set, the route may for example be continued at a position associated with an associated gateway defined by another navigation data set and computing the route may be continued at least partially based on this other navigation data set.

For example, gateways G1 defined by the first navigation data set 111 and the second navigation data set 121 are associated by corresponding entries in global gateway tables GT110 and GT120, because gateway G1 defined by the first navigation data set 111 is identified by an entry in global gateway table GT110 and gateway G1 defined by the second navigation data set 121 is identified by an entry in global gateway table GT120 and both entries have the same gateway identifier and/or the same tile identifier; and gateways G2 defined by the first navigation data set 111 and the third navigation data set 112 are associated by corresponding entries in global gateway table GT110, because both are identified by an entry in global gateway table GT110 and both entries have the same gateway identifier and/or the same tile identifier. In this example, only the region identifiers of corresponding entries of associated gateways differ. These region identifiers may be used to identify the navigation data sets linked by the associated gateways, for example to switch from one navigation data set to another navigation data set when computing a route.

As described above, associated gateways may form a routing link between a road network of a map of a geographic region represented by a navigation data set and a road network of a map of an at least partially adjacent and/or at least partially overlapping geographic region represented by another navigation data set. As exemplary shown in FIG. 3a, associated gateways G1 form a routing link between the road network of map M111 of geographic region R111 and the road network of map M121 of geographic region R121; and associated gateways G2 form a routing link between the road network of map M111 of geographic region R111 and the road network of map M112 of geographic region R112.

FIG. 4a is a block diagram of an exemplary embodiment of a server 300 according to the first and third aspects of the invention.

Server 300 comprises a processor 301. Processor 301 may represent a single processor or two or more processors, which are for instance at least partially coupled, for instance via a bus. Processor 301 executes a program code stored in program memory 302 (for instance program code causing server 300 to perform one or more of the embodiments of a method (or parts thereof) according to the first aspect of the, when executed on processor 301), and interfaces with a main memory 303. Some or all of memories 302 and 303 may also be included into processor 301. One of or both of memories 302 and 303 may be fixedly connected to processor 301 or at least partially removable from processor 301, for instance in the form of a memory card or stick. Program memory 302 may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. Program memory 302 may also comprise an operating system for processor 301. Program memory 302 may for instance comprise a first memory portion that is fixedly installed in server 300, and a second memory portion that is removable from server 300, for instance in the form of a removable SD memory card. Main memory 303 may for instance be a volatile memory. It may for instance be a DRAM memory, to give non-limiting example. It may for instance be used as a working memory for processor 301 when executing an operating system and/or programs.

Processor 301 further controls a communication interface 304 configured to receive and/or output data and/or information. For instance, communication interface 304 may be configured to communicate with a navigation device 400 (see FIGS. 4b and 4c). This may for instance comprise receiving information such as requests from the navigation device 400 and/or transmitting information such as a computed route and/or navigation data (e.g. one or more navigation data sets and/or a navigation data source) to the navigation device 400. The communication may for instance be based on a wireless communication connection. The communication interface 304 may thus comprise circuitry such as modulators, filters, mixers, switches and/or one or more antennas to allow transmission and/or reception of signals, e.g. for the communication with navigation device 400. In embodiments of the invention, communication interface 304 is inter alia configured to allow communication according to a 2G/3G/4G/5G cellular communication system and/or a non-cellular communication system, such as for instance a WLAN network. Nevertheless, the communication connection between server 300 and navigation device 400 may equally well at least partially comprise wire-bound portions. For instance, server 300 may be connected to a back-bone of a wireless communication system (associated with navigation device 400) via a wire-bound system such as for instance the internet.

The components 302-306 of server 300 may for instance be connected with processor 301 by means of one or more serial and/or parallel busses.

FIG. 4b is a block diagram of an exemplary embodiment of a navigation device 400 according to the second and third aspects of the invention. For instance, the navigation device 400 is or forms a part (e.g. as a module) of a GNSS-enabled smartphone or a navigation device of a vehicle.

Navigation device 400 comprises a processor 401. Processor 401 may represent a single processor or two or more processors, which are for instance at least partially coupled, for instance via a bus. Processor 401 executes a program code stored in program memory 402 (for instance program code causing navigation device 400 to perform one or more of the embodiments of a method (or parts thereof) according to the second aspect of the invention, when executed on processor 401), and interfaces with a main memory 403. Some or all of memories 402 and 403 may also be included into processor 401. One of or both of memories 402 and 403 may be fixedly connected to processor 401 or at least partially removable from processor 401, for instance in the form of a memory card or stick. Program memory 402 may for instance be a non-volatile memory. In program memory 402, a navigation database such as navigation database 100 may be stored. Program memory 402 may also comprise an operating system for processor 401. Program memory 402 may for instance comprise a first memory portion that is fixedly installed in navigation device 400, and a second memory portion that is removable from navigation device 400, for instance in the form of a removable SD memory card. Main memory 403 may for instance be a volatile memory. It may for instance be used as a working memory for processor 401 when executing an operating system and/or programs.

Processor 401 further controls a communication interface 404 configured to receive and/or output data and/or information. For instance, communication interface 404 may be configured to communicate with the server 300 as described above. The communication may for instance be based on a wireless communication connection.

The communication interface 404 may thus comprise circuitry such as modulators, filters, mixers, switches and/or one or more antennas to allow transmission and/or reception of signals, e.g. for the communication with navigation device 400. In embodiments of the invention, communication interface 404 is inter alia configured to allow communication according to a 2G/3G/4G/5G cellular communication system and/or a non-cellular communication system, such as for instance a WLAN network. Nevertheless, the communication connection between server 300 and navigation device 400 may equally well at least partially comprise wire-bound portions.

Processor 401 further controls a user interface 405 configured to present information to a user of navigation device 400 and/or to receive information from such a user. User interface 405 may for instance be the standard user interface via which a user of navigation device 400 controls other functionality thereof, such as finding/searching a destination position, entering a routing request, etc. An example for such a user interface is a touch sensitive display.

Processor 401 may further control an optional GNSS interface 406 configured to receive positioning information of an GNSS such as Global Positioning System (GPS), Galileo, Global Navigation Satellite System (i.e. “Globalnaja Nawigazionnaja Sputnikowaja Sistema”, GLONASS) and Quasi-Zenith Satellite System (QZSS).

The components 402-406 of navigation device 400 may for instance be connected with processor 401 by means of one or more serial and/or parallel busses.

FIG. 4c is a block diagram of an exemplary embodiment of a navigation system 500 according to the third aspect of the invention. System 500 comprises a server represented by server 300 and a navigation device represented by navigation device 400 as described above.

As illustrated in FIG. 4c, server 300 may communicate via communication connection 501 with navigation device 400. Communication connection 501 may be a bi-directional connection. Communication connection 501 may be a wireless communication connection such as a cellular-connection (e.g. a connection in a 2G/3G/4G/5G communication system) and/or a non-cellular connection (e.g. a connection in a non-cellular communication system, such as for instance a WLAN network). Nevertheless, communication connection 501 may equally well at least partially comprise wire-bound portions. For example, server 300 may be connected to a back-bone of a wireless communication system (associated with navigation device 400, i.e. the navigation device) via a wire-bound system such as for instance the internet or a local area network (LAN, e.g. an Ethernet).

System 500 may be a hybrid navigation system in which a navigation database (e.g. navigation database 100 as described above) with one or more navigation data sets of a first type (e.g. navigation data sets 111 to 11n) are cached and/or permanently stored on navigation device 400 (i.e. the navigation device) and one or more navigation data sets of a second type (e.g. navigation data sets 121 to 12n) are received at navigation device 400 from server 300 if required for computing a route and/or for navigating along a computed route and/or for displaying a computed route.

FIG. 5 is a flow chart 600 illustrating an exemplary embodiment of a method according to the second aspect of the invention. The actions of flow chart 600 may be performed by navigation device 400, for example. Processor 401 and the program code stored in memory 402 of navigation device 400 may cause the navigation device 400 to perform some or all of the actions 601 to 604 when program code is retrieved from memory 402 and executed by processor 400.

Navigation device 400 stores and or receives a navigation data source according to the first aspect of the invention (action 601). In the following, it is assumed that the navigation data source according to the first aspect of the invention is represented by navigation database 100 as described above with respect to FIG. 1.

The navigation database 100 (or one or more navigation data files representing navigation database 100) may be stored in program memory 402. Alternatively or additionally, the navigation database 100 or a part of the navigation database 100 (or one or more navigation data files representing navigation database 100 or a part of navigation database 100, for example navigation data files for updating navigation database 100) may be received by communication interface 404 at navigation device 400 and, subsequently, navigation database 100 (or one or more navigation data files representing navigation database 100) may be stored in program memory 402. In the exemplary embodiment of system 500, the navigation database 100 or a part of the navigation database 100 may be received from server 300 by communication interface 404 at navigation device 400.

A routing request for computing a route is received by user interface 405 at navigation device 400, wherein the routing request at least defines a starting position and a destination position for the route (action 602). For example, the routing request may comprise an address and/or geographic coordinates as destination position. Furthermore, the routing request may define the current position of navigation device 400 to be the starting position. For example, navigation device 400 may determine its current position by GNSS interface 406. Alternatively or additionally, the routing request may also comprise an address and/or geographic coordinates as starting position.

The route is computed at least partially based on the routing request and the navigation database 100, wherein the route includes the position associated with the first gateway G1 (action 603). Computing the route at least partially based on the routing request and the navigation database 100 may be understood to mean that a route from the starting position to the destination position is computed at least partially based on the navigation data comprised in the navigation database 100. For example, the route may be computed by processor 401 of navigation device 400.

In certain embodiments of the second aspect of the invention, at least a first portion of the route from the starting position to the destination position is computed based on the first navigation data set 111, and a second portion of the route is computed based on the second navigation data set 121. In these embodiments, the first portion of the route and the second portion of the route may be linked via a routing link formed between the gateways G1 defined by the first navigation data set 111 and the second navigation data set 121. Accordingly, the first portion of the route and the second portion of the route may meet each other at the position associated with the gateways G1 such that the computed route may include this position.

Alternatively or additionally, computing the route is caused in action 603. In the exemplary embodiment of system 500, causing computing the route may be understood to mean that a request for computing the route is transmitted from navigation device 400 to server 300 such that server 300 is caused to compute the route at least partially based on the routing request and the navigation database 100 (e.g. program memory 302 of server 300 comprises a navigation database a copy of which is transmitted as navigation database 100 to navigation device 400). The computed route (and navigation database 100) may be received at the navigation device 400 from the server 300. Accordingly, if only computing the route is caused in action 603, action 601 (i.e. storing and/or receiving navigation database 100) may for example be performed after action 603 or simultaneously to action 603.

Subsequently, the computed route is provided (action 604). For example, the computed route is provided by processor 401 of navigation device 400 for navigating along the computed route and/or for displaying on user interface 405 of apparatus 405.

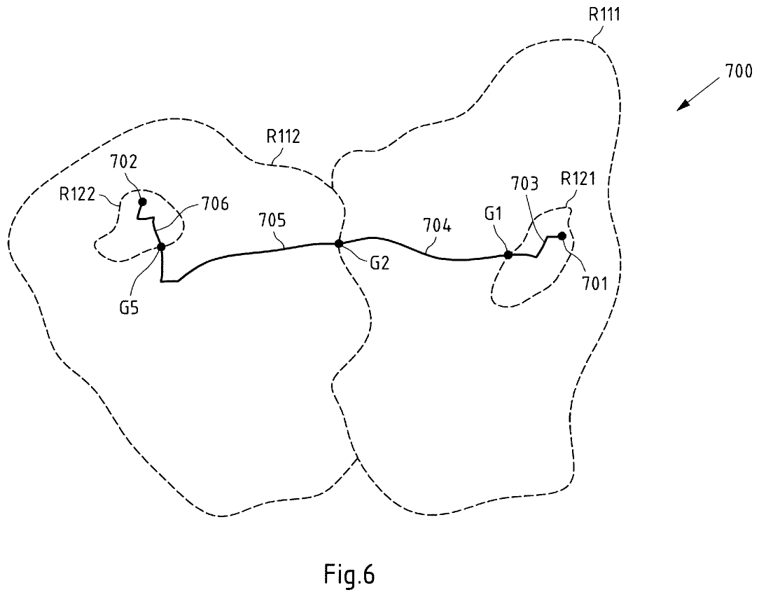

FIG. 6 is a schematic illustration of a computed route 700. Route 700 may for example be computed and/or caused to be computed in action 603 of flowchart 600. Route 700 is computed based on navigation database 100. The starting position 701 of route 700 is located in geographic region R121 (i.e. the starting region) and the destination position 702 of route 700 is located in geographic region R122 (i.e. the destination region). As shown in FIG. 6, route 700 includes the position of gateways G1, G2 and G5.

In certain embodiments of the second aspect of the invention, the first portion 703 of route 700 may be computed based on the second navigation data set 121 representing map M121 of geographic region R121 (i.e. a map with a high(er) level of detail of the starting region); and the last portion 706 of route 700 may be computed based on the fourth navigation data set 122 representing map M122 of geographic region R122 (i.e. a map with a high(er) level of detail of the destination region). The second and third portions 704 and 705 of route 700 may then be computed based on the first and third navigation data sets 111 and 112 representing maps 111 and 112 of geographic region R111 and 112 (i.e. maps with a low(er) level of detail). In these embodiments, the route computing may switch from one navigation data set to another navigation data set at the positions associated with the gateways G1, G2 and G5. Accordingly, the first portion 701 and the second portion of 704 may be linked via a routing link formed between the gateways G1 defined by the first navigation data set 111 and the second navigation data set 121; the second portion of 704 and the third portion 705 may be linked via a routing link formed between the gateways G2 defined by the second navigation data set 121 and the third navigation data set 112; and the third portion 705 and the last portion 706 may be linked via a routing link formed between the gateways G3 defined by the third navigation data set 112 and the fourth navigation data set 122.

The present invention thus allows to switch easily between maps of different and/or at least partially overlapping geographic having different level of details when computing a route, for example between maps with a low(er) level of detail (e.g. standard definition SD maps such as Advanced Driver Assistance maps) and maps with a high(er) level of detail (e.g. high definition (HD) maps such as Advanced Driver Assistance HD maps). This may be used to reduce the bandwidth required for navigation data updates and/or for communicating navigation data. Alternatively or additionally, this may be used for efficiently computing routes by computing one or more portions of the route based on maps with a higher level of details and one or more portions of the route based on maps with a lower level of detail. For example, the maps with a higher level of detail may for example be used if there are available; otherwise, the maps with a lower level of detail may be used. Alternatively or additionally, the maps with a higher level of detail may for example be used for computing the route in the starting region and/or the destination region and/or in other regions with conditions triggering the computing to be switched on such a map; otherwise, the maps with a lower level of detail may be used. Conditions triggering the computing to be switched to a map with a higher level of detail may be a traffic jam and/or a road blocking in this region.

FIG. 7 is a schematic illustration of examples of tangible computer-readable storage media according to the present invention that may for instance be used to implement program memory 302 of FIG. 4a and/or program memory 402 of FIG. 4b. To this end, FIG. 7 displays a flash memory 800, which may for instance be soldered or bonded to a printed circuit board, a solid-state drive 801 comprising a plurality of memory chips (e.g. Flash memory chips), a magnetic hard drive 802, a Secure Digital (SD) card 803, a Universal Serial Bus (USB) memory stick 804, an optical storage medium 805 (such as for instance a CD-ROM or DVD) and a magnetic storage medium 806.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 300 and 400 of FIGS. 4a and 4b, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

1. A navigation data source, said navigation data source comprising:
a first navigation data set of a first type, wherein said first navigation data set represents a map of a first geographic region, wherein said first navigation data set further defines a first gateway, wherein said first gateway is associated with a position within said first geographic region and spaced from a border of said first geographic region, and wherein said first gateway is associable with a gateway defined by a second navigation data set of a second type.

2. The navigation data source according to claim 1, wherein said second navigation data set represents a map of a second geographic region, wherein said second geographic region is a sub-region and/or an overlapping region of said first geographic region.

3. The navigation data source according to claim 1, wherein said first gateway defined by said first navigation data set and said gateway defined by said second navigation data set are associated with the same position.

4. The navigation data source according to claim 1, wherein said first gateway defined by said first navigation data set is associated with said gateway defined by said second navigation data set.

5. The navigation data source according to 4 claim 1, said navigation data source further comprising:
said second navigation data set.

6. The navigation data source according to claim 1, wherein said first gateway is one of a first set of gateways defined by said first navigation data set, wherein each gateway of said first set of gateways is associated with a position within said first geographic region and spaced from a border of said first geographic region, and wherein each gateway of said first set of gateways is associable with a gateway defined by said second navigation data set or another navigation data set of said second type.

7. The navigation data source according to claim 1, wherein said first navigation data set further defines a second gateway, wherein said second gateway is associated with a position at a border of said first geographic region, and wherein said second gateway is associable with a gateway defined by a third navigation data set of said first type.

8. The navigation data source according to claim 7, wherein said third navigation data set represents a map of a third geographic region, and wherein said third geographic region is an adjacent region of said first geographic region.

9. The navigation data source according to claim 7, wherein said second gateway defined by said first navigation data set and said gateway defined by said third navigation data set are associated with the same position.

10. The navigation data source according to claim 7, wherein said second gateway defined by said first navigation data set is associated with said gateway defined by said third navigation data set.

11. The navigation data source according to claim 7, said navigation data source further comprising:
said third navigation data set.

12. The navigation data source according to claim 7, wherein said second gateway is one of a second set of gateways defined by said first navigation data set, wherein each gateway of said second set of gateways is associated with a position at a border of said first geographic region, and wherein each gateway of said second set of gateways is associable with a gateway defined by said third navigation data set or another navigation data set of said first type.

13. The navigation data source according to claim 1, wherein a level of detail of said map represented by said first navigation data set is lower than a level of detail of said map represented by said second navigation data set.

14. The navigation data source according to claim 1, said navigation data source further comprising:
a plurality of navigation data sets of said first type, wherein said first navigation data set is one of said plurality of navigation data sets of said first type, wherein said plurality of navigation data sets of said first type represents a first plurality of independent maps of adjacent geographic regions, wherein each navigation data set of said plurality of navigation data sets of said first type represents one specific map of said first plurality of independent maps of adjacent geographic regions.

15. The navigation data source according to claim 1, said navigation data source further comprising:
a plurality of navigation data sets of said second type, wherein said second navigation data set is one of said plurality of navigation data sets of said second type, wherein said plurality of navigation data sets of said second type represents a second plurality of independent maps of adjacent sub-regions and/or overlapping regions of said first geographic region, wherein each navigation data set of said plurality of navigation data sets of said second type represents one specific map of said second plurality of independent maps of adjacent sub-regions and/or overlapping regions of said first geographic region.

16. A storage medium comprising a navigation data source, said navigation data source comprising a first navigation data set of a first type, wherein said first navigation data set represents a map of a first geographic region, wherein said first navigation data set further defines a first gateway, wherein said first gateway is associated with a position within said first geographic region and spaced from a border of said first geographic region, and wherein said first gateway is associable with a gateway defined by a second navigation data set of a second type.

17. A method, said method comprising:
storing and/or receiving a navigation data source comprising a first navigation data set of a first type, wherein said first navigation data set represents a map of a first geographic region, wherein said first navigation data set further defines a first gateway, wherein said first gateway is associated with a position within said first geographic region and spaced from a border of said first geographic region, and wherein said first gateway is associable with a gateway defined by a second navigation data set of a second type;
receiving a routing request for computing a route, wherein said routing request at least defines a starting position and a destination position for said route;
computing said route and/or causing computing said route at least partially based on said routing request and said navigation data source, wherein said route includes said position associated with said first gateway; and
providing said computed route.

18. The method according to claim 17, wherein said starting position and/or said destination position are within said second geographic region, and wherein said computing said route is at least partially based on said first navigation data set and at least partially based on said second navigation data set.

19. (canceled)

20. A navigation device, said navigation device comprising:
at least one processor; and
at least one memory including computer program code;
wherein said at least one memory and said computer program code are configured to, with said processor, cause said navigation device to at least perform:
storing and/or receiving a navigation data source comprising a first navigation data set of a first type, wherein said first navigation data set represents a map of a first geographic region, wherein said first navigation data set further defines a first gateway, wherein said first gateway is associated with a position within said first geographic region and spaced from a border of said first geographic region, and wherein said first gateway is associable with a gateway defined by a second navigation data set of a second type;
receiving a routing request for computing a route, wherein said routing request at least defines a starting position and a destination position for said route;
computing said route and/or causing computing said route at least partially based on said routing request and said navigation data source, wherein said route includes said position associated with said first gateway; and
providing said computed route.
